(19) United States
(12) Patent Application Publication
(10) Pub. No.: US 2021/0111473 A1
(43) Pub. Date: Apr. 15, 2021

(54) SPINWAVE WAVE RESONATOR

(71) Applicant: IMEC VZW, LEUVEN (BE)

(72) Inventors: Hanns Christoph ADELMANN, WILSELE (BE); Florin CIUBOTARU, HEVERLEE (BE); Xavier ROTTENBERG, KESSEL-LO (BE); Hendrikus TILMANS, MAASMECHELEN (BE); Bruno FIGEYS, HERENT (BE)

(21) Appl. No.: 17/055,546

(22) PCT Filed: May 14, 2019
(86) PCT No.: PCT/EP2019/062282

§ 371 Date: Nov. 13, 2020

(30) Foreign Application Priority Data
May 14, 2018 (EP) 18172058.2

(51) Int. Cl. H01P 7/08

(52) U.S. Cl. CPC H01P 7/08

(57) ABSTRACT

A resonator for spin waves, wherein the resonator comprises a stack of material layers arranged on a substrate, a waveguide structure formed in at least one material layer in the stack and configured to propagate a spin wave and to confine a spin wave propagating in a waveguide element of the waveguide structure, such that a spin wave of a selected frequency propagating in the waveguide structure is arranged to resonate in the waveguide structure. The resonator further comprises a control mechanism formed in at least one material layer in the stack and configured to adapt at least one property of the waveguide structure for tuning the resonance frequency of the waveguide structure.

### TECHNICAL FIELD

The present invention generally relates to the field of resonators. More specifically, the present invention relates to resonators relying on magnetostatic waves or spin waves for operation at microwave frequencies.

### BACKGROUND

Information and communication technology (ICT) has experienced immense advancements during the recent decades thanks to miniaturization in semiconductor electronics and progress in optical (photonic) technologies. However, further downscaling, following Moore's law, inevitably leads to other challenges, wherein an example of such a challenge is an increasing heat dissipation per unit area. More specifically, it is widely acknowledged in the semiconductor community that the miniaturisation of conventional transistors, such as Complementary Metal Oxide Semiconductor (CMOS) transistors, is challenging and for many applications there is a need for alternative device structures. The scaling of CMOS is due to several concurrent fundamental and practical limits related to transistor operation and manufacturability. Hence, the issue of thermal dissipation becomes critical with scaling down the gate length of a transistor to the nanometer range due to the quantum mechanical effects which drastically increase leakage currents. Furthermore, the miniaturization of systems such as smart phones is hampered by the limited scaling of the passive components, such as the radio frequency (RF) filters of the systems.

The recent research on spins and magnets may be especially promising in this respect. Spin-based technologies are highly interesting for replaceing conventional charge-based microelectronic circuits and when trying to fulfill the high demands of the electronics of tomorrow. A spin wave is a collective excitation of magnetic moments in magnetic materials, wherein the magnetic materials may include ferromagnets, antiferromagnets, ferrimagnets, or the like. A controlled spin wave with a desired frequency and wavelength range may be employed in various information processing devices, microwave delay lines, local oscillators, filters, spin wave-optical devices, etc.

It should be noted that for a given frequency, spin waves have shorter wavelengths (by several orders) than that of electromagnetic waves or light waves. Hence, contrary to electromagnetic waves, the wavelength of spin waves matches the micromanufacturing space for frequencies in the GHz range.

One possible application of spin wave technology could be in RF filters. RF filters are widely used in wireless communication systems like mobile phones, Bluetooth modules, satellite navigation and communication, and wireless local area networks (WLAN). It should be noted that the number of RF filters used in a single mobile (smart) phone typically ranges from three to seven filters for 3G, but this is expected to increase for the next generations (e.g., to above 10 filters for 4G and approaching 100 filters for 5G). However, integrated on-chip solutions for RF filters are currently mainly based on LC circuits, and as the integrated LC filters are typically limited by the inductor size (which may be in the order of at least 10⁴ μm² per inductor), these filters are relatively large. Furthermore, the limited performance of LC filters has the consequence that these filters are in fact not usable for today's wireless communication devices. It is also known in the art to use devices such as surface acoustic wave (SAW) or bulk acoustic wave (BAW) filters displaying high performance characteristics. However, also devices of this kind are relatively large with respect to typical integrated circuits, and the chip size may be in the order of one mm². SAW and BAW filters are furthermore difficult to integrate on-chip, and are also difficult to scale without increased losses. It should be noted that SAW filters are moreover limited in performance and its maximum operating frequency. Moreover, as the frequency of SAW and BAW filters is not or barely tunable, a dedicated filter is needed for each spectrum band, which adds to the area cost.

Hence, there is a need for tunable filters, preferably tunable filters that can be manufactured using semiconductor fabrication technologies, more preferably tunable filters that are monolithically integrated with CMOS electronic circuitry.

As an alternative to the above-mentioned techniques, arrangements for generating and oscillating spin waves using various techniques have been suggested in the prior art. And, although the frequency is tunable, also these arrangements generally suffer from relatively large dimensions, leading to inconvenient and/or bulky devices including arrangements of this kind.

EP3089227 describes a device configured as one or both of a spin wave generator or a spin wave detector. In one aspect, the device includes a magnetostrictive film and a deformation film physically connected to the magnetostrictive film. The device also includes an acoustic isolation surrounding the magnetostrictive film and the deformation film to form an acoustic resonator. When the device is configured as the spin wave generator, the deformation film is configured to undergo a change in its physical dimensions in response to an actuation, where the change in the physical dimensions of the deformation film induces a mechanical stress in the magnetostrictive film to cause a change in the magnetization of the magnetostrictive film. When the device is configured as the spin wave detector, the magnetostrictive film is configured to undergo a change in physical dimensions in response to a change in magnetization, wherein the change in the physical dimensions of the magnetostrictive film induces a mechanical stress in the deformation film causing an electrical signal in the deformation film.

The article “Efficient excitation and detection of standing spin wave in Permalloy film: Demonstration of spin wave resonator” by Kiseki et al., Applied Physics Letters 101, 212404 (2012) describes a magnetic resonator for magnetostatic spin waves. The resonator, which consists of periodical nonmagnetic electrodes on a ferromagnetic metallic film, excites a standing magnetostatic spin wave with a specific wavelength. An external magnetic field is applied to influence the resonance frequency of the resonator.

However, the devices of the prior art are relatively complex, and are furthermore unable to provide an adequate control of the resonance frequency. Hence, there is a need to provide an arrangement for spin wave resonance which may improve the control of the resonance frequency, preferably on-chip, whilst being relatively compact and manufacturable using semiconductor fabrication technologies.

### SUMMARY OF THE INVENTIVE CONCEPT

It is an object of the invention to improve the above techniques and the prior art. In particular, it is an object to provide a relatively compact arrangement or device for generating and propagating spin waves, wherein a resonance of the spin waves is generated and the frequency of the resonance is controlled. Further, methods for generating and controlling the resonance of spin waves using the provided devices are also provided.

This and other objects are achieved by providing a resonator for spin waves and a method for generating spin waves having the features in the independent claims. Preferred embodiments are defined in the dependent claims.

Hence, according to a first aspect of the present invention, there is provided a resonator for spin waves. The resonator comprises a stack of material layers arranged on a substrate. The resonator further comprises a waveguide structure formed in at least one material layer in the stack and configured to propagate a spin wave and to confine a spin wave propagating in a waveguide element of the waveguide structure, such that a spin wave of a selected frequency propagating in the waveguide structure is arranged to resonate in the waveguide structure. The resonator further comprises a control mechanism formed in at least one material layer in the stack and configured to adapt at least one property of the waveguide structure for tuning the resonance frequency of the waveguide structure.

According to a second aspect of the present invention, there is provided a method for generating resonance of spin waves of a selected frequency using a resonator according to the first aspect of the present invention by adapting at least on property of the waveguide structure thereby tuning the resonance frequency of the waveguide structure. The method thus comprises the step of adapting at least one property of the waveguide structure for tuning the resonance frequency of the waveguide structure. The method comprises the step of propagating a spin wave in the waveguide structure and confining the spin wave propagating in the waveguide element of the waveguide structure, such that a spin wave of the selected frequency propagating in the waveguide structure is arranged to resonate in the waveguide structure.

Thus, the present invention is based on the idea of providing a resonator for spin waves, wherein the resonator, for example, may be used in filters or filter arrangements. The resonator has a stacked layer structure. Hence, the compact resonator of the present invention is monolithic in its configuration. The waveguide structure is configured to propagate and oscillate a spin wave in the waveguide element of the waveguide structure, and to generate a resonance of the spin wave of a selected frequency. The control mechanism is configured to adapt one or more properties of the waveguide structure for tuning the resonance frequency of the waveguide structure to obtain the selected frequency. The resonator hereby provides a relatively compact and convenient device or arrangement which is able to achieve and control a spin wave resonance in an efficient and energy-saving manner.

A resonator for spin waves (including magnetostatic waves) is provided. It should be noted that the present application is mainly related to two kinds of spin waves, namely standing (stationary) spin waves and travelling waves. The standing spin waves require reflection resulting in interference, whereas the travelling waves may propagate along the surface of the waveguide element.

By the term “resonator”, it is hereby meant a device or an arrangement for spin waves naturally oscillating at frequencies (so-called resonant frequencies) with greater amplitude than at other frequencies. The resonator, including the control mechanism, may also be interpreted as a “tunable resonator”.

The resonator of the present invention comprises a stack of material layers arranged on a (single) substrate. By the term “stack of material layers”, it is hereby meant that material layers are arranged or stacked on top of each other. The resonator further comprises a waveguide structure formed in at least one material layer in the stack. For example, the waveguide structure may comprise a first set of material layers (e.g. a first chip) and the control mechanism may comprise a second set of material layers (e.g. a second chip), whereby the first and second chips are operationally coupled.

By the term “waveguide structure”, it is hereby meant a structure in which a spin wave may be guided. The waveguide structure is configured to propagate a spin wave and to confine or retain a spin wave propagating in a waveguide element of the waveguide structure. Hence, the waveguide structure comprises a waveguide element (which also may be configured as a cavity) in which a spin wave is configured to propagate and in which the propagating spin wave may be confined or retained. It should be noted that travelling spin waves, which propagate along the surface of the waveguide element, by definition also propagate within the waveguide structure (material). A spin wave of a selected frequency propagating in the waveguide structure is arranged to resonate in the waveguide structure. In other words, the waveguide structure is configured to provide resonance for the spin wave of a selected frequency by oscillation of the spin wave with greater amplitude than at other frequencies.

It will be appreciated that the spin wave propagating in the waveguide structure may be generated by different techniques and/or arrangements. For example, the spin wave may be generated by a transducer arrangement according to an embodiment of the present invention.

The resonator further comprises a control mechanism formed in at least one material layer of the stack. The control mechanism is configured to adapt at least one property of the waveguide structure for tuning the resonance frequency of the waveguide structure. Hence, the control mechanism is configured to adapt, modify, adjust and/or control one or more properties (e.g. physical (including geometrical) and/or magnetic (material) properties) of the waveguide structure for tuning the resonance frequency.

By the term “tuning”, it is hereby meant adapting, adjusting, modifying, controlling and/or modulating the waveguide structure with respect to the spin wave frequency. More specifically, in this context, the term “tuning the waveguide structure” may indicate adapting or adjusting the resonance frequency of the waveguide structure. Hence, in its broadest interpretation and in this context, “tuning” may imply substantially any influence by the control mechanism on the waveguide structure for an adaptation and/or an adjustment to the resonant frequency of the spin wave. In its more specific interpretation, and as exemplified in one or more embodiments, “tuning” may imply adapting and/or adjusting one or more physical and/or magnetic properties of the waveguide structure for an adaptation and/or an adjustment to the resonant frequency of the spin wave resonator.

The present invention is advantageous in that the control mechanism of the resonator may conveniently and efficiently adapt one or more properties of the waveguide structure such that a spin wave resonance at a desired frequency may be achieved. It will be appreciated that the devices according to the prior art may suffer from an inadequate control of the resonance frequency of the devices. In contrast, by the innovative concept of the resonator of the present invention, the waveguide structure is conveniently tuned by the control mechanism to the spin wave frequency for generating resonance of the spin wave. Furthermore, the resonator of the present invention is also tunable over a relatively wide frequency range.

The present invention is advantageous in that the control mechanism of the resonator is very versatile regarding the different options for providing the control. More specifically, and which will be apparent by the numerous embodiments in the forthcoming description, the control mechanism of the resonator may be adapted to specific requirements of the resonator.

The present invention is further advantageous in that the configuration of the resonator as a stack of material layers arranged on a substrate constitutes a relatively compact arrangement. In one embodiment, the resonator of the present invention is monolithic and/or the elements/components of the resonator are monolithically integrated. It will be appreciated that the resonator may encompass hybrid integration, e.g. using chip bonding. For example, the resonator may comprise a two-chip arrangement, wherein one chip may comprise the waveguide structure and the other chip may comprise the control mechanism. Hence, in principle, the present invention may provide a relatively small, space and cost-saving arrangement for generating spin wave resonance. This feature of the resonator of the present invention is highly important when considering the requirements for further downscaling the electronics.

In another embodiment, the control element is monolithically integrated on a first chip, while the waveguide structure is monolithically integrated on another, second chip. Both chips are bonded to each other to be operationally linked, thereby forming a resonator according to this invention.

The present invention is further advantageous regarding several aspects compared to acoustic-based resonators (e.g., SAW or BAW-type). In the first place, whereas SAW and/or BAW-type resonators may have a limited tunability (or may not even be tunable at all), the resonator of the present invention may be tunable to a relatively high degree. Furthermore, compared to acoustic-based resonators, the resonator of the present invention may be more compact and have a higher upper frequency and a larger frequency range (while retaining a relatively low rate of energy loss, i.e., a relatively high Q-factor).

It will be appreciated that the resonator of the present invention furthermore may be manufactured using semiconductor fabrication technologies, more in particular CMOS compatible processing technologies, which are highly beneficial regarding size, processing efficiency and/or cost.

According to an embodiment of the present invention, the control mechanism may be encompassed by the waveguide structure. Hence, the control mechanism may be enclosed by the waveguide structure or integrated (comprised) in the waveguide structure. For example, the control mechanism and the waveguide structure may be arranged in the same at least one layer. The present embodiment is advantageous in that the resonator may be made even more compact.

According to an embodiment of the present invention, the waveguide element may be formed by a magnetic material configured to propagate a spin wave. Hence, the waveguide element may comprise or constitute a magnetic material, e.g. ferrimagnetic yttrium iron garnet (YIG) or a ferromagnetic metal like Co, Fe, Ni or its alloys containing one or more of these materials in which a spin wave may propagate.

According to an embodiment of the present invention, the waveguide structure may comprise a reflector arrangement configured to confine a propagating spin wave in the waveguide element by reflection of the spin wave. In this way, the embodiment retains the spin wave in the waveguide structure (thus preventing spin waves from ‘escaping’), which leads to a relatively high quality Q-factor. By the term “reflector arrangement”, it is hereby meant substantially any arrangement, configuration, device and/or element(s) which is configured or able to reflect an incident (spin) wave. The spin wave reflected by the reflector arrangement may hereby be constructively interfered, resulting in forming a stationary, standing spin wave with a specific frequency. In this context, the reflector arrangement is configured to reflect a spin wave such that a standing spin wave at the desired frequency is generated within the waveguide element and that the spin wave is confined in the waveguide structure. However, it should be noted that the waveguide structure does not necessarily have to comprise a reflector arrangement for the purpose of confining a spin wave arising in the waveguide element. For example, the waveguide structure may comprise a closed contour configured to confine a circulating traveling spin wave in the waveguide element such that constructive (positive) interference of the circulating spin wave may be obtained.

According to an embodiment of the present invention, the waveguide element may extend along a principal axis of spin wave propagation, and the reflector arrangement may comprise reflective interfaces at the respective end of the waveguide element. Hence, the waveguide element may have a substantially elongated shape along which the spin wave may propagate with its wave front. Furthermore, at each edge of the waveguide element, there may be a reflective interface for spin wave reflection. By the term “reflective interface”, it is here meant substantially any interface or surface which is able or configured to reflect and change the propagating direction of a spin wave.

According to an embodiment of the present invention, the reflector arrangement may comprise at least one of a periodic reflector array. Such a periodic reflector array can be a Bragg reflector. By “Bragg reflector”, it is hereby meant a periodic reflective array, mirror, or the like, for reflecting spin waves. More specifically, the Bragg reflector may constitute a mirror or mirror array which may comprise a plurality of thin material layers. The mirror or mirror array may furthermore comprise a (non-magnetic) metal, e.g. Aluminium. It will be appreciated that by providing one or more Bragg reflectors in the resonator, a high reflectivity of the incident spin wave may be obtained. The embodiment of the present invention is hereby advantageous regarding the preservation of the spin wave in the waveguide structure during operation of the resonator.

According to an embodiment of the present invention, the reflector arrangement may comprise at least one non-magnetic medium. For example, the non-magnetic medium may comprise a dielectric material, e.g. silicon oxide. Alternatively, the non-magnetic medium may constitute e.g., a gaseous medium. By the term “gaseous medium”, it is hereby meant substantially any medium in its gaseous state. For example, the reflector arrangement may comprise a noble gas, air, or the like, for the purpose of reflecting the incident spin wave.

According to an embodiment of the present invention, the control mechanism may be configured to adapt at least one physical property of the waveguide structure. By the term “physical property”, it may be meant e.g. (a) dimension(s), geometry, structure, form, configuration, etc., of the waveguide structure material. In other words, the control mechanism may be configured to adapt, control and/or change the length, volume, structure, form, or the like, of the waveguide structure and/or the waveguide element. The embodiment of the present invention is advantageous in that the control mechanism, by changing one or more physical properties of the waveguide structure, may tune the resonance frequency of the waveguide structure.

According to an embodiment of the present invention, the control mechanism is configured to adapt at least one magnetic property of the waveguide structure, the material of the waveguide structure and/or the waveguide element material. By the term “magnetic property”, it may be meant e.g. magnetisation, magnetic susceptibility, etc., of the waveguide structure material. In other words, the control mechanism may be configured to adapt, control and/or change the magnetisation of the waveguide structure material and/or waveguide element material. The embodiment of the present invention is advantageous in that the control mechanism even to a further extent may tune the resonance frequency of the waveguide structure.

According to an embodiment of the present invention, the control mechanism may further be configured to adapt at least one property of the reflector arrangement. Hence, the control mechanism may be configured to control and/or change one or more properties of the reflector arrangement, e.g. one or more physical and/or magnetic properties of the reflector arrangement.

According to an embodiment of the present invention, the resonator may further comprise at least one transducer arrangement coupled to the waveguide structure and configured to generate or excite a spin wave in the waveguide structure, or alternatively, to pick-up or detect the spin wave in the waveguide structure. It is noted that the same transducer can be used both for excitation and detection of the spin wave. The resonator may comprise a deformation element configured to change its physical dimensions in response to an electrical actuation, and a magnetostrictive element (physically) coupled to the deformation element. A change in physical dimensions of the deformation element in response to the electrical actuation results in a mechanical stress and/or deformation in the magnetostrictive element, resulting in turn to a change in magnetisation or generation of magnetic field in the material of the magnetostrictive element which in turn may result in the generation of a spin wave in the waveguide structure. In response to an alternating actuation (e.g. an alternating signal, such as a voltage or a current), the deformation element may deform also in an alternating motion. Consequently, a change in mechanical stress arises in the magnetostrictive element which in its turn leads to a change in magnetisation in the magnetostrictive element. This, in its turn, leads to a generation of a spin wave in the waveguide structure. By the term “transducer arrangement”, it is meant a transducer device or arrangement for converting energy from one form to another, e.g., electrical energy to magnetic energy. By the term “magnetostrictive element”, it is meant an element composed of a magnetostrictive material (typically a ferromagnetic material) which is able to change its shape or dimensions when subjected to a magnetic field (or magnetic induction or magnetisation). The embodiment of the present invention is advantageous in that a spin wave may be generated in the waveguide structure of the resonator in an efficient manner. Furthermore, the relatively low number of components of the resonator implies that a relatively compact and/or monolithically created resonator is provided for generating spin waves and for resonance thereof.

According to an embodiment of the present invention, there is provided a resonator arrangement comprising an array of at least two resonators of any one of the preceding embodiments. The waveguide structures and control mechanisms of the at least two resonators may be arranged on a common substrate, thereby maintaining the compact concept of the present invention even in case of an array of a plurality of resonators.

According to an embodiment of the present invention, there is provided a filter arrangement for processing at least one signal. The filter arrangement comprises at least one resonator (i.e. a resonator or a multiple resonator arrangement) of any one of the preceding embodiments. The filter arrangement further comprises an electrical input port coupled to the resonator(s), wherein the electrical input port is configured to transmit an input spectrum to the resonator(s). The resonator is configured to generate an output spectrum based on a resonance of the spin wave in the waveguide structure resulting from the input spectrum. The filter arrangement further comprises an electrical output port coupled to the resonator, wherein the electrical output port is configured to transmit the output spectrum from the resonator. Hence, the embodiment of the present invention represents a filter (e.g. a RF or microwave filter) which, by means of a resonance of the spin wave in the waveguide structure in the resonator, may filter an input spectrum and transmit an output spectrum as a result of the filtering. Furthermore, the filter arrangement may constitute a low-pass filter or a high-pass filter. The embodiment is advantageous in that the innovative resonator of the present invention is comprised in an arrangement for filtering signals, thereby leading to a compact, convenient, flexible and energy-efficient filter arrangement.

Furthermore, compared to filters of SAW-type and/or BAW-type, the filter arrangement of the embodiment provides numerous advantages, e.g. regarding size, frequency range, tunability, bandwidth and/or manufacturing techniques. For example, the size of the filter arrangement may approximately be as small as 0.01 mm², whereas SAW-type and/or BAW-type filters are typically in the order of 1 mm². Hence, the area ratio between the filter arrangement and the SAW/BAW-type filter may be in the order of 100. Furthermore, regarding the filter frequency range, it will be appreciated that signals of relatively high frequencies (e.g. higher than 1 GHz, 10 GHz or even 60 GHz) may be filtered by the filter arrangement. Filters of SAW-type and/or BAW-type, on the other hand, may be limited to filtering frequencies lower than 3 GHz and 10 GHz, respectively. Furthermore, whereas the filter arrangement of the embodiment of the present invention may be tunable over a relatively wide frequency range, filters of SAW-type or BAW-type are very limited in their tunability, or may not be tunable at all. Moreover, whereas manufacturing of filters of SAW-type and/or BAW-type may be relatively circumstantial and complex, the filter arrangement may be advantageously manufactured. For example, the filter arrangement of the embodiment may be manufactured using semiconductor fabrication technologies (above all a CMOS compatible processing technology). Therefore, based on the above observations, and considering that RF filters of today are predominantly of acoustic wave type, the innovative resonator of the filter arrangement of the present invention may lead to significant improvements of filter technology.

According to an embodiment of the method of the present invention of the second aspect, the method may further comprise the step of generating a spin wave in the waveguide structure. For example, and in case there is provided a filter arrangement according to the above-mentioned embodiment, the method may comprise the step of providing an electrical actuation signal to the deformation element for changing its physical dimensions or shape, the electrical actuation signal resulting in a mechanical stress (or deformation) in the magnetostrictive element, resulting in a change in magnetization of the magnetostrictive element and resulting in a generation of a spin wave in the waveguide structure. In case of the electrical actuation signal being an alternating electrical actuation, the frequency may be between 1 GHz and 100 GHz, or even outside this range.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIGS. 1a-b are schematic views of a resonator according to exemplifying embodiments of the present invention,

FIGS. 2a-b are schematic view of spin waves propagating in a resonator according to an exemplifying embodiment of the present invention,

FIGS. 3a-e are schematic views of resonators according to exemplifying embodiments of the present invention,

FIG. 4 is a schematic view of a filter arrangement according to an exemplifying embodiment of the present invention,

FIG. 5 is a schematic flow chart of a method according to an exemplifying embodiment of the present invention, and

FIGS. 6a-h are schematic views of a control mechanism of a resonator according to exemplifying embodiments of the present invention.

### DETAILED DESCRIPTION

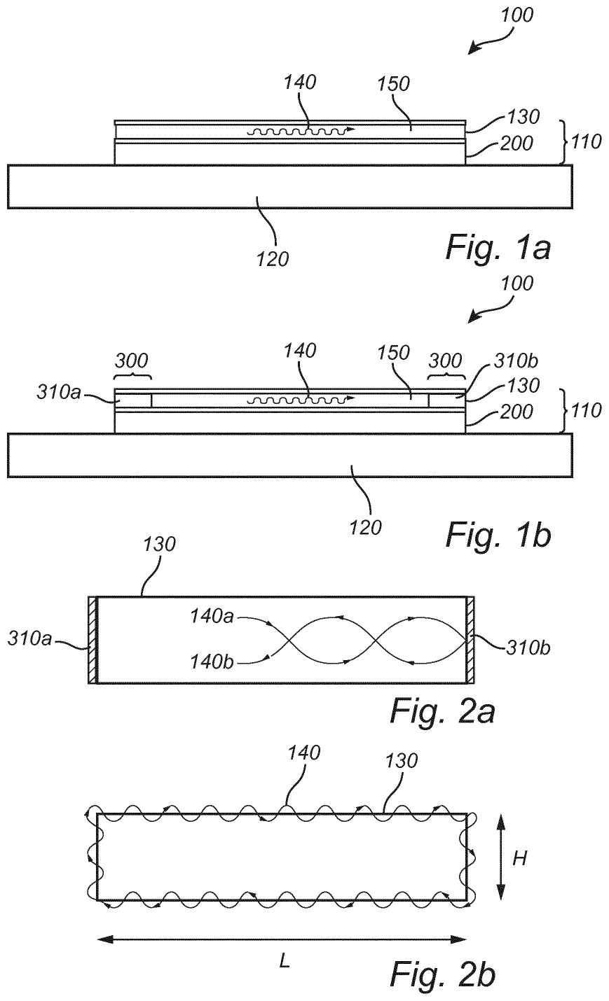

FIG. 1a is a schematic view of a resonator 100 for spin waves according to an exemplifying embodiment of the present invention.

The resonator 100 comprises a stack of material layers 110 arranged on a substrate 120. It will be appreciated that the substrate 120 may be a semiconductor substrate, and the resonator 100 may hereby be advantageously manufactured using semiconductor fabrication technologies (more in particular, a CMOS compatible processing technology). The resonator 100 may furthermore be monolithically integrated/manufactured above a semiconductor or CMOS circuitry.

The resonator 100 comprises a waveguide structure 130 formed in at least one material layer in the stack 110. The waveguide structure 130 comprises a waveguide element 150, which may be a film, wire, strip, or the like, which furthermore may comprise a ferromagnetic, ferrimagnetic, antiferromagnetic or ferrite material strip. Hence, embodiments of the present invention are not necessarily limited to ferromagnetic waveguide structures 130, and it will be appreciated that the waveguide structure 130 may comprise substantially any material having magnetic properties suitable for the propagation of spin waves, and the associated quasi-particles called magnons. For example, the waveguide structure 130 may comprise an antiferromagnetic material. The waveguide structure 130 may alternatively comprise a ferromagnetic material, such as ferromagnetic metal based on iron, copper, nickel or alloys thereof, or heterostructures formed from such materials, e.g. NiFe, CoFe, CoNi, CoFeB or CoPt. The waveguide structure 130 may also comprise a ferrite material, e.g. oxides based on Fe, Ba, Y, Sr, Zn and/or Co.

The waveguide structure 130 may extend longitudinally, having a major longitudinal dimension and a minor transverse dimension in a plane parallel to the substrate 120. For example, the minor transverse dimension may be relatively small such as to allow propagation of spin waves 140 through the waveguide structure 130 along one directional axis, e.g. corresponding to the longitudinal dimension of the waveguide structure 130. It should be noted that the spin wave 140 may also propagate perpendicular to the longitudinal dimension of the waveguide structure 130, i.e. in the direction of the thickness of the waveguide structure 130.

The waveguide structure 130 may for example be a structure having a width, i.e. in a direction orthogonal to a longitudinal orientation of the waveguide and parallel to the substrate 120, that is less than or equal to 10 μm, e.g. less than or equal to 1 μm, or less than or equal to 750 nm, e.g. in the range of 350 nm to 650 nm, e.g. 500 nm. The waveguide structure 130 may furthermore have a length, e.g. in the longitudinal direction thereof, which is greater than or equal to 5 μm, e.g. greater than or equal to 7.5 μm, e.g. in the range of 8 μm to 30 μm, e.g. in the range of 9 μm to 20 μm, e.g. in the range of 10 μm to 15 μm. Alternatively, the width of the waveguide structure 130 may be in the order of 100 μm, whereas the length may be in the range of 10-20 μm. The waveguide structure 130 may be adapted for conducting spin waves 140 having microwave frequencies, e.g. in the gigahertz range, e.g. higher than or about equal to 1 GHz, higher than or equal to 10 GHz, higher than or equal 5 to 20 GHz, e.g. higher than or equal to 40 GHz, or even higher, e.g. 60 GHz or higher. The present invention is advantageous in that it can be implemented on a micro/nanoscale, e.g. having physical dimensions smaller than the wavelength in free space of an electromagnetic wave in the microwave spectrum.

The waveguide structure 130 is configured to propagate a spin wave 140 and to confine a spin wave 140 propagating in the waveguide element 150 of the waveguide structure 130, such that a spin wave 140 of a selected frequency propagating in the waveguide structure 130 is arranged to resonate in the waveguide structure 130. Hence, the waveguide structure 130 is configured to provide resonance for the spin wave 140 of a selected frequency by oscillation of the spin wave 140 in the waveguide element 150.

The resonator 100 comprises a control mechanism 200 formed in at least one material layer in the stack 110. In this example, the control mechanism 200 is provided between the substrate 120 and the waveguide element 130. However, other arrangements are feasible, wherein the control mechanism 200 may be provided in proximity to or in direct physical contact with the waveguide structure 130. For example, the control mechanism 200 may be arranged on top of the waveguide structure 130.

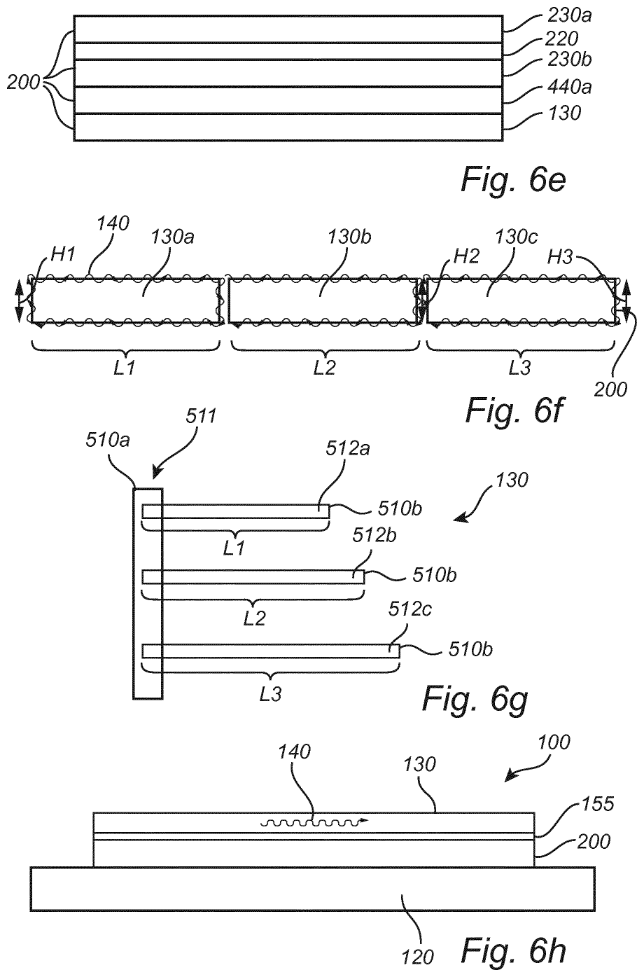

The control mechanism 200 is configured to adapt at least one property of the waveguide structure 130 for tuning the resonance frequency of the waveguide structure 130. Hence, the control mechanism 200 is configured to adapt one or more properties of the waveguide structure 130 so as to tune the resonant frequency of the waveguide structure 130. More specifically, the control mechanism 200 may, e.g. by virtue of being arranged in a close vicinity or in physical contact with the waveguide structure 130, influence, adapt and/or adjust one or more physical and/or magnetic properties of the waveguide structure 130 for an adaptation and/or an adjustment of the waveguide structure 130 to the resonant frequency of the spin wave 140. Examples of control mechanisms 200 according to the above-mentioned concepts are presented in FIGS. 6a-h and the associated text. It will be appreciated that the resonator 100 as exemplified in FIG. 1a may be used for both standing spin waves 140 as well as travelling spin waves 140.

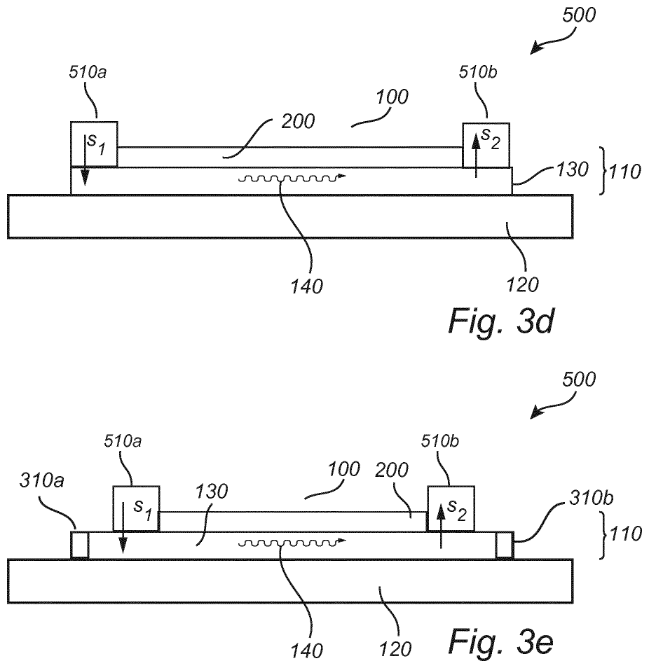

It should be noted that the resonator 100 as shown in FIG. 1a does not indicate any port and/or transducer element. However, resonators comprising such ports and/or transducer elements are further described in FIGS. 3a-e.

FIG. 1b is a schematic view of a resonator 100 for spin waves according to an exemplifying embodiment of the present invention. It will be appreciated that FIG. 1b has many features in common with the resonator 100 of FIG. 1a, and it is hereby referred to FIG. 1a and the associated text for an increased understanding. Compared to the resonator 100 of FIG. 1a, the resonator 100 in FIG. 1b further comprises a reflector arrangement 300. The waveguide element 150 of the waveguide structure 130 extends along a principal axis of the propagation of the spin wave 140, and the reflector arrangement 300 comprises a reflective interface 310a, 310b at the respective end of the waveguide element 150. The reflector arrangement 300 is configured to confine or detain a spin wave 140 propagating in the waveguide element 150 by reflection of the spin wave 140. The reflector arrangement 300 may comprise a periodic reflective array (Bragg-type reflector) for spin wave reflection. Alternatively, or in combination herewith, the reflector arrangement 300 may comprise a magnetic discontinuity composed of a non-magnetic material e.g., a noble gas, air, or the like, for the purpose of reflecting the incident spin wave 140. In the resonator 100 of FIG. 1b, only standing spin waves 140 of integers n of half the spin wave wavelength λ can exist in the waveguide element 150 of the resonator 100, i.e. n·λ/2. In contrast, in case of travelling spin waves, only travelling spin waves of integers n of the spin wave wavelength λ can exist, i.e. n·λ. Analogously with the resonator 100 of FIG. 1a, the control mechanism 200 of the resonator 100 of FIG. 1b is configured to adapt at least one property of the waveguide structure 130 for tuning the resonance frequency of the waveguide structure 130.

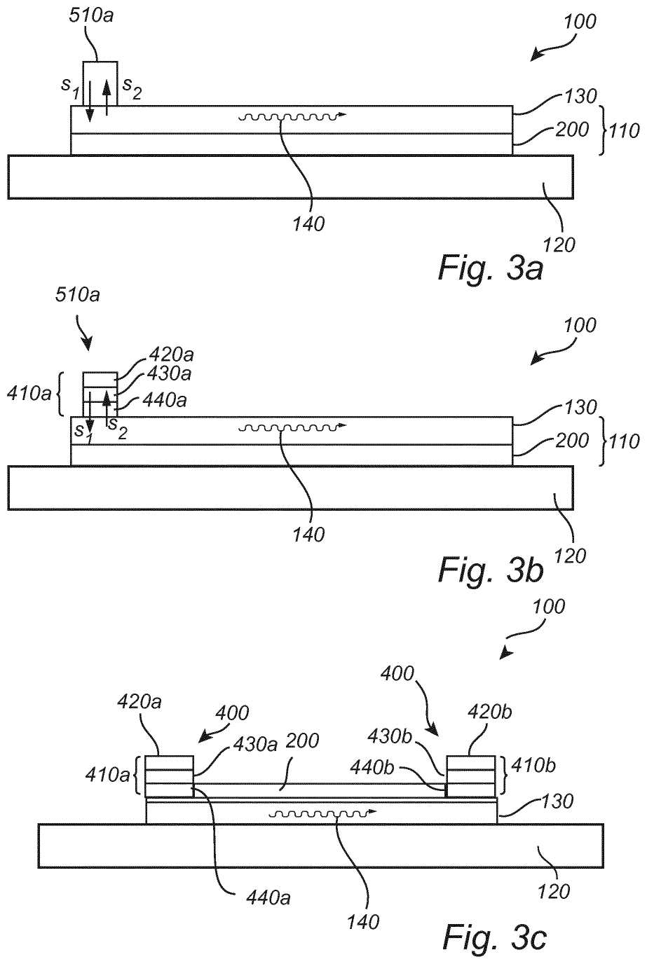

FIGS. 2a-b are schematic views of spin waves 140 propagating in a resonator 100 according to an exemplifying embodiment of the present invention.

In FIG. 2a, an incident spin wave 140a which propagates in the waveguide structure 130 of the resonator 100 of FIG. 1b is reflected at the reflective interface 310a and 310b thereby creating standing waves 140a and 140b. Consequently, a reflected spin wave 140b propagates in the waveguide structure 130. Hence, FIG. 2a shows a standing spin wave in the bulk of the waveguide structure 130, which is reflected by the oppositely arranged reflective interfaces 310a and 310b. The control mechanism 200 of the resonator 100 is configured to adapt at least one property of the waveguide structure 130 for tuning the resonance frequency of the waveguide structure 130.

FIG. 2b shows a schematic view of a waveguide element 130, without such a reflector arrangement 310a, 310b, of a resonator according to an exemplifying embodiment. Here, a spin wave 140 travels along a surface of the perimeter of the waveguide structure 130. Hence, compared to the arrangement of FIG. 2a, no reflective interfaces are provided in this embodiment of the resonator. The circumference C of the waveguide structure 130 is C=2L+2H, wherein L is the length of the waveguide structure 130 and H is the height of the waveguide structure 130. It will be appreciated that the spin wave 140 furthermore may travel perpendicular to the direction as indicated in FIG. 2b. Accordingly, the circumference C of the waveguide structure 130 for this propagation of the spin wave 140 is C=2W+2H, wherein W is the width of the waveguide structure 130. The control mechanism of the resonator is configured to control at least one property of the waveguide structure 130 such that the circumference C corresponds to integers n of the spin wave wavelength λ, i.e. C=n·λ. In this way, the control mechanism 200 may tune the resonance frequency of the waveguide structure 130.

FIGS. 3a-e are schematic views of resonators 100 according to exemplifying embodiments of the present invention. It will be appreciated that the resonators 100 of FIGS. 3a-e have many features in common with the resonators 100 of FIGS. 1a and 1b, and it is hereby referred to those figures and the associated text for an increased understanding.

Compared to the resonator 100 of FIG. 1a, the resonator 100 in FIG. 3a further comprises at least one schematically indicated input/output (I/O) or port 510a. In one embodiment, the port 510a may comprise a stack of elements and/or layers, and may alternatively be referred to as a two-terminal or transducer element. The terminal 510a is configured to convert an (electrical) input signal s₁ into a magnetic signal carried by the spin wave 140. Furthermore, the resonator 100 is configured to tune the resonance frequency of the waveguide structure 130 via the control mechanism 200. In this way, the resonator 100 may generate an output signal s₂ and read the output signal s₂ via the terminal 510a. In case of a resonator having one I/O port, the output signal s₂ will be maximal at the resonance frequency of the spin wave 140, e.g. as observed in the impedance seen by the port 510a. It will be appreciated that the resonator 100 is operable for both standing spin waves 140 as well as for travelling spin waves 140.

FIG. 3b is an exemplifying embodiment of the resonator 100 of FIG. 3a. Here, the input/output (I/O) or port 510a comprises a stack of elements and/or layers 410a. The port 510a comprises, in a top-down direction, an electrode 420a, a deformation element 430a configured to change its physical dimensions in response to an electrical (alternating) actuation, and a magnetostrictive element 440a coupled to the deformation element 430a. Alternatively, the deformation element 430a may be provided between (i.e. sandwiched) two electrode layers, i.e. the terminals of two I/O ports 510a, 510b (not shown). As yet another alternative, the electrode 420a may be provided under the deformation element 430a. For example, the electrode layer 420a may comprise two electrodes, and the deformation element 430a may be sandwiched between the two electrodes. The magnetostrictive element 440a may comprise Terfenol-D, TbₓDy₁₋ₓFe₂; Galifenol, GaₓFe₁₋ₓ; Co; Ni; a Heusler alloy or a combination thereof, which is advantageous in that well known and easily available materials may be used in the magnetostrictive element 430a.

The electrode 420a, the deformation element 430a and the magnetostrictive element 440a may be provided in (close) proximity to or in direct physical contact with the neighbouring layer of the port 510a. The deformation element 430a is advantageously arranged in direct physical contact with the magnetostrictive element 440a.

The port 510a is configured to convert an input signal s₁ into a magnetic signal carried by a spin wave 140. More specifically, the spin wave 140 may be generated by the port 510a in the following way: an actuation signal (e.g. a voltage) supplied to the port 510a via the electrode 420a results in a change of the physical dimensions of the deformation element 430a. Consequently, there is a mechanical deformation or mechanical stress induced in the associated magnetostrictive element 440a, resulting in a change in magnetization of the magnetostrictive element 440a, which in turn may result in a generation of a spin wave 140 in the waveguide structure 130 of the resonator 100. The resonator 100 may further comprise a control mechanism 200 according to any one of the previously described embodiments. Hence, the control mechanism 200 is configured to adapt at least one property of the waveguide structure 130 for tuning the resonance frequency of the waveguide structure 130 generated by the resonator 100. It will be appreciated that the resonator 100 is operable for both standing spin waves 140 as well as for travelling spin waves 140.

FIG. 3c is a schematic view of a resonator 100 comprising a transducer arrangement 400 as input/output (I/O) port according to an exemplifying embodiment of the present invention. The transducer arrangement 400 is coupled to the waveguide structure 130 and configured to generate a spin wave 140 in the waveguide structure 130. In this example, the transducer arrangement 400 comprises two stacks 410a, 410b arranged on the waveguide structure 130 and spaced apart along the longitudinal direction of the waveguide structure 130. However, it should be noted that the transducer arrangement 400, as an alternative, may be provided with a single, unique stack, as illustrated in FIG. 3b. Each of the stacks 410a, 410b comprises, in a top-down direction, an electrode 420a,b, a deformation element 430a,b configured to change its physical dimensions in response to an electrical (alternating) actuation, and a magnetostrictive element 440a,b coupled to the deformation element 430a,b. Alternatively, the deformation element 430a,b may be provided between (i.e. sandwiched) two electrode layers.

The electrodes 420a,b, the deformation elements 430a,b, and the magnetostrictive elements 440a,b may be provided in (close) proximity to or in direct physical contact with the neighbouring layer of the respective stack 410a, 410b. The deformation elements 430a,b are advantageously arranged in direct physical contact with the magnetostrictive elements 440a,b.

It will be appreciated that one of the two port stacks 410a, 410b as exemplified may be configured to generate a spin wave, whereas the other of the two stacks 410a, 410b may be configured to detect the generated spin wave. The two stacks 410a, 410b may hereby constitute ports, e.g. an input port 410a and an output port 410b (or vice versa). During operation of the transducer arrangement 400, an actuation signal supplied to one of the electrodes 420a,b results in a change of the physical dimensions of the associated deformation element 430a,b. Consequently, there is a mechanical deformation or mechanical stress induced in the associated magnetostrictive element 440a,b, resulting in a change in magnetization of the magnetostrictive element 440a,b, which in turn results in a generation of a spin wave 140 in the waveguide structure 130. The resonator 100 further comprises a control mechanism 200 according to any one of the previously described embodiments. The control mechanism 200 is configured to adapt at least one property of the waveguide structure 130 for tuning the resonance frequency of the waveguide structure 130 generated by the transducer arrangement 400. The spin wave 140, which may be generated by one of the two stacks 410a, 410b, may analogously be detected by one of the two stacks 410a, 410b.

Although not shown in FIG. 3c, there may alternatively be an array of at least two resonators 100 comprising a transducer arrangement 400, wherein the waveguide structures 130 and control mechanisms 200 of the at least two resonators 100 are arranged on a common substrate 120.

FIG. 3d is a schematic view of a filter arrangement 500 according to an exemplifying embodiment of the present invention. The filter arrangement 500 comprises a resonator 100 of any one of the preceding embodiments. As the structure, arrangement and/or function of the resonator 100 is the same or similar to that or those already described in the previous text and/or figures, it is hereby referred to that or those sections. The filter arrangement 500 further comprises input/output (I/O) ports which are exemplified as an electrical input port 510a and an electrical output port 510b which are coupled to the resonator 100, e.g. as exemplified in one or more of FIGS. 3a-c. The electrical input port 510a and the electrical output port 510b are arranged on the waveguide structure 130 and are spaced apart from each other along the longitudinal direction of the waveguide structure 130. The electrical input port 510a may comprise an input transducer for converting an input signal s₁ into a spin wave 140 having substantially the same, e.g. having the same, spectrum as the input signal s₁. Analogously, the electrical output port 510b may comprise an output transducer for converting the filtered spin wave 140 into an output signal s₂ having substantially the same, e.g. having the same, spectrum as the filtered spin wave 140. The input transducer and/or the output transducer may, for example, comprise a magneto-electric transducer and/or a co-planar waveguide antenna. The electrical input port 510a is configured to transmit the input signal s₁ having a frequency band to the resonator 100. The resonator 100 is configured to filter the input signal s₁ based on a resonance of the spin wave 140 in the waveguide structure 130. The filtering of the resonator 100 results in the output signal s₂ having a frequency band, wherein the control mechanism 200 of the resonator 100 is configured to adapt the waveguide structure 130 for its tuning of the resonance frequency. The electrical output port 510b of the filter arrangement 500 is configured to transmit the output signal s₂ from the resonator 100.

FIG. 3e is a schematic view of a filter arrangement 500 according to an exemplifying embodiment of the present invention. The filter arrangement 500 is similar to that described in FIG. 3d, and it is hereby referred to that figure and associated text. Compared to the filter arrangement 500 in FIG. 3d, the filter arrangement 500 in FIG. 3e further comprises a reflector arrangement according to one or more of the previously described embodiments. The filter arrangement 500 is hereby applicable for standing spin waves. The reflector arrangement comprises a reflective interface 310a, 310b at the respective end of the waveguide element 130. The electrical input port 510a is configured to transmit an input signal s₁ to the resonator 100. The resonator 100 is configured to filter the input signal s₁ based on a resonance of the spin wave 140 in the waveguide structure 130. The filtering of the resonator 100 results in an output spectrum signal s₂, wherein the control mechanism 200 of the resonator 100 is configured to adapt the waveguide structure 130 for its tuning of the resonance frequency. The electrical output port 510b of the filter arrangement 500 is configured to transmit the output spectrum signal s₂ from the resonator 100.

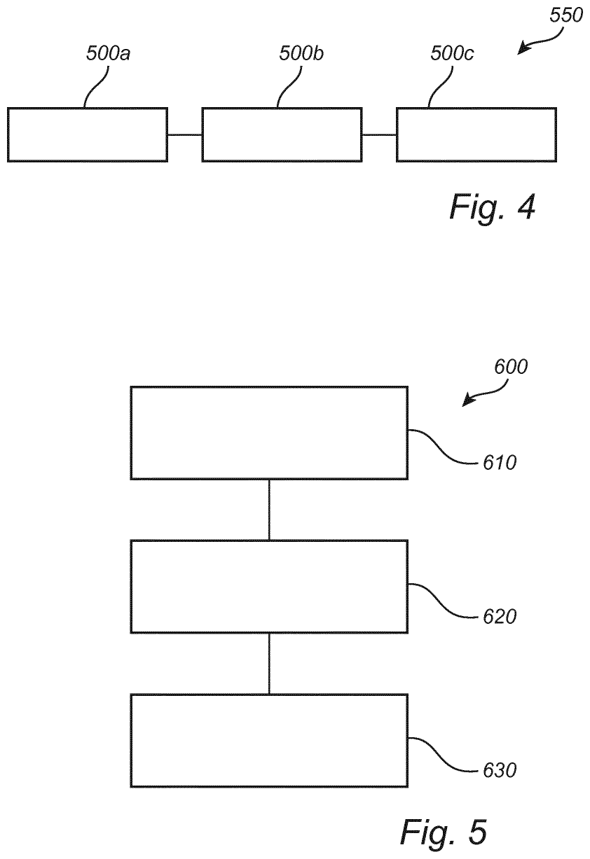

FIG. 4 is a schematic view of a filter array 550 comprising a plurality of schematically indicated resonators 500a-c according to one or more of the previously described embodiments. It should be noted that the number of resonators 500a-c is arbitrary, and that there may be more or fewer resonators in the filter array 550. The resonators 500a-c may be combined in substantially any desired configuration such that the desired transfer function of the filter array 550 is obtained. For example, the filter array 550 may be designed as a band-pass filter by connecting a plurality of resonators 500a-c. For example, the filter array 550 may be designed as a high-pass filter by connecting a plurality of resonators 500a-c of high-pass type. In this way, a high-order high-pass filter may be obtained. As yet another alternative, the filter array 550 may comprise a first plurality of resonators which may constitute a low-pass filter, wherein the first plurality of resonators may be arranged in parallel with a second plurality of resonators which, in contrast, may constitute a high-pass filter.

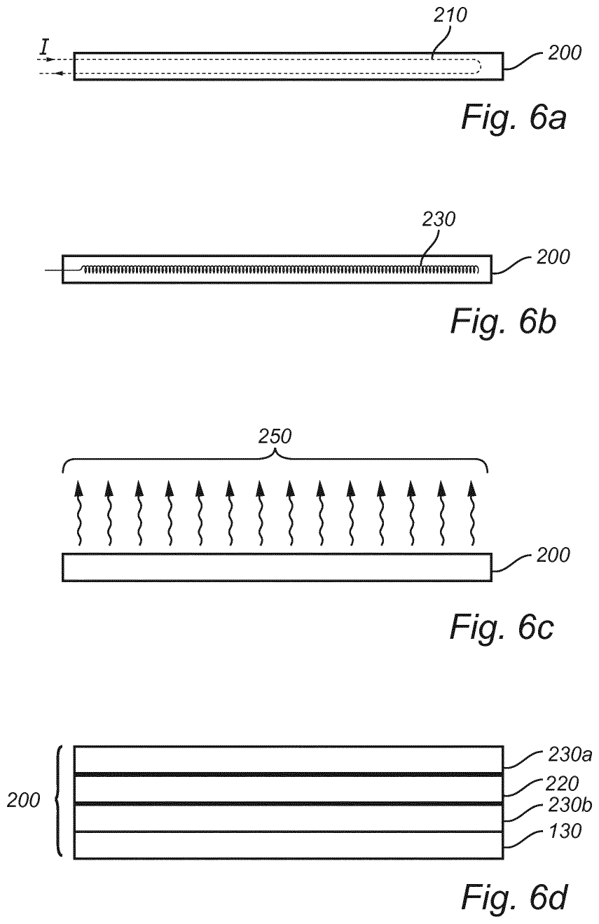

FIG. 5 is a schematic flow chart of a method 600 for generating resonance of spin waves having selected frequency using a resonator according to the first aspect of the present invention. The method 600 comprises the step of generating and propagating 610 a spin wave in the waveguide structure and confining 620 the spin wave propagating in the waveguide element of the waveguide structure, such that a spin wave of a selected frequency propagating in the waveguide structure is arranged to resonate in the waveguide structure. The method further comprises the step of adapting 630 at least one property of the waveguide structure for tuning the resonance frequency of the spin wave resonator (or waveguide structure). Optionally, the method comprises generating a spin wave in the waveguide structure prior to controlling the resonance of the waveguide structure to determine the resonance frequency.

FIGS. 6a-d are schematic views of control mechanisms 200 of a resonator according to exemplifying embodiments of the present invention. Generally, in case a signal (e.g., a voltage or a current) or power is supplied to the control mechanism(s) in the following examples, it is typically a signal that is constant for a longer period of time in order to keep the resonance frequency fixed during that period.

In FIG. 6a, the control mechanism 200 is formed in a material layer of a stack, e.g. as shown in FIGS. 1a-b and/or FIGS. 3a-e. The control mechanism 200 comprises an antenna-like structure, comprising a coil 210 through which a current I is arranged to pass. It will be appreciated that the coil 210 may have substantially any shape, e.g. a spiral shape or a simple wire. During operation of the control mechanism 200, the current I in the coil 210 creates a magnetic field in the material layer around which the control mechanism 200 is formed, which in its turn influences the waveguide element 150 of the waveguide structure 130 arranged on the material layer of the control mechanism 200. Hence, the control mechanism 200 is hereby configured to adapt at least one magnetic property (e.g., the magnetisation of the waveguide material) of the waveguide structure 130 for tuning the resonance frequency of the spin wave 140 in the resonator 100.

FIGS. 6b-d show examples wherein the control mechanism 200 may be configured to adapt at least one physical property of the waveguide structure 130 for tuning the resonance of the spin wave 140 in the resonator 100. The control mechanism 200 may be formed in a material layer of a stack, e.g. as shown in FIGS. 1a-b and/or FIGS. 3a-e.

In FIG. 6b, the control mechanism 200 is of thermomechanical type, and comprises a heating element 230. It will be appreciated that the heating element 230 may constitute or comprise substantially any element or device for providing an increase in temperature, e.g. a heating resistor or resistive coil. During operation of the control mechanism 200, the heating element 230 may transfer heat to the waveguide structure 130 being in thermal contact with the heating element 230, e.g. by direct physical contact between the material layer of the control mechanism 200 and the waveguide structure 130. Consequently, there may be a thermal expansion (or retraction) which may change the dimensions of the waveguide structure 130 for tuning the resonance of the waveguide structure 130 in the resonator 100. Furthermore, during operation of the control mechanism 200, the heat from the heating element 230 will cause a mechanical stress in the waveguide structure 130.

In FIG. 6c, the control mechanism 200 is of thermomechanical type, and involves optical heating. More specifically, the control mechanism 200 comprises a photon source 250, e.g. an (optical) light source. During operation, the photon source 250 of the control mechanism 200 may radiate the adjacently arranged waveguide structure 130 with photons. The light is absorbed in the waveguide structure 130 and causes thermomechanical stress in the waveguide structure 130. The photons radiated to the waveguide structure 130 may influence one or more physical and/or magnetic properties of the waveguide structure 130 for tuning the resonance frequency of the waveguide structure 130 of the resonator.

In FIG. 6d, the control mechanism 200 is arranged as a stack of material layers. The control mechanism 200 comprises, in a top-down direction, a first electrode 230a, a deformation element 220, a second electrode 230b, and a waveguide structure 130. The deformation element 220 of the control mechanism 200 is configured to change its physical dimensions in response to an electrical actuation signal. For example, the deformation element 220 may comprise a piezoelectric element. The piezoelectric element may comprise PbZrTiO₃, PZT; PbMgN-bOₓ—PbTiOₓ, PMN-PT; BaTiO₃, BTO; SrBiTaOₓ, SBT; AlN; GaN; LiNbO₃, LNO; ZnO; (K,Na)NbOₓ, KNN; orthorhombic HfO₂ or a combination thereof. During operation of the control mechanism 200, an electrical signal (voltage or current) provided to the electrodes 230a,b deforms the deformation element 220, which in turn deforms the waveguide structure 130. Hence, mechanical stress is exerted on the waveguide structure 130. One or more physical (geometrical) properties of the waveguide structure 130 may be adapted and/or adjusted, e.g. the length, width, etc. Consequently, the resonance frequency of the waveguide structure 130 may hereby be tuned.

In FIG. 6e, the control mechanism 200 is arranged as a stack of material layers, similar to the arrangement as shown in FIG. 6d. The control mechanism 200 comprises, in a top-down direction, a first electrode 230a, a deformation element 220, a second electrode 230b, a magnetostrictive layer 440a, and a waveguide structure 130.

The electrodes 230a,b, the waveguide structure 130, the deformation element 220 and the magnetostrictive layer 440a may be provided in (close) proximity to or in direct physical contact with the neighbouring layers.

During operation of the control mechanism 200, an actuation signal (e.g. a voltage) supplied to one of the electrodes 230a,b results in a change of the physical dimensions of the associated deformation element 220. Consequently, there is a mechanical deformation or mechanical stress induced in the associated magnetostrictive element 440a, which in turn results in the creation of a changing magnetic field applied to the waveguide structure 130. Consequently, the resonance frequency of the waveguide structure 130 of the resonator may hereby be tuned.

FIG. 6f shows a schematic view of a control mechanism 200 of a resonator according to an exemplifying embodiment of the present invention and according to the principle as shown in FIG. 2b. Here, the resonator comprises a plurality of waveguide structures 130a-c arranged longitudinally in series. It should be noted that the number and/or size of the waveguide structures 130a-c may be arbitrary. The control mechanism 200 of the resonator is configured to determine which waveguide structure(s) of the plurality of waveguide structures 130a-c to use in the propagation of the spin wave 140 in the resonator. For example, the control mechanism 200 may be configured to determine that the waveguide structure 130a should be used for the propagation of the spin wave 140. The spin wave 140 may hereby travel along a surface of the perimeter of the waveguide structure 130a. The circumference C1 of the waveguide structure 130a is C1=2L1+2H1, wherein L1 is the length of the waveguide structure 130a and H1 is the height of the waveguide structure 130a. The circumference C1 corresponds to integers n of the spin wave wavelength λ, i.e. C1=n·λ. Alternatively, the control mechanism 200 may be configured to determine that the waveguide structures 130a and 130b should be used for the propagation of the spin wave 140b. The spin wave 140b may hereby travel along a surface of the perimeter of the waveguide structures 130a and 130b. The circumference C2 of the waveguide structure 130 is C2=2L1+2L2+H1+H2, wherein L1 is the length of the waveguide structure 130a, L2 is the length of the waveguide structure 130b, H1 is the height of the waveguide structure 130a and H2 is the height of the waveguide structure 130b. The control mechanism 200 is configured to control at least one property of the waveguide structure 130 such that the circumference C2 corresponds to integers n of the spin wave wavelength λ, i.e. C2=n·λ. In this way, the control mechanism 200 may tune the resonance frequency of the waveguide structure 130. Analogously, and as yet another alternative, the control mechanism 200 may be configured to determine that the waveguide structures 130a-c should be used for the propagation of the spin wave 140b, whereby the circumference C3 along the waveguide structure for the travelling spin wave is C3=2L1+2L2+2L3+H1+H3.

FIG. 6g shows a schematic top view of a waveguide structure 130 of a resonator according to an exemplifying embodiment of the present invention. The resonator comprises a first port 510a, which is arranged at a first position 511 on the waveguide structure 130. The resonator further comprises a second port 510b arranged at a second position 512a-c of the waveguide structure 130, wherein the distance between the first port 510a and the second port 510b constitutes an effective predetermined distance L1, L2 or L3. According to this example, the control mechanism of the resonator is configured to select a waveguide structure 130 with an appropriate length. For example, a first waveguide structure 130 may have the effective length L1 between the first terminal 510a and a second port 510b arranged at the second position 512a. Analogously, a second (or third) waveguide structure 130 may have the effective length L2 (or L3) between the first port 510a and a second port 510b arranged at the second position 512b (or the third position 512c). It should be noted that the number of waveguide lengths is arbitrary, and that the three lengths of the waveguide structure between the positions 511 and the positions 512a-c, respectively, have been indicated for illustrative purposes only. The control mechanism (not shown) of the resonator may hereby be configured to select which waveguide structure 130 to use for selecting the effective length of the waveguide structure 130 between the first port 510a and the second port 510b. Consequently, the control mechanism may adapt the effective length of the waveguide structure for tuning the resonance frequency of the waveguide structure of the resonator.

FIG. 6h shows yet another embodiment of the resonator 100 according to an example. In accordance with one or more of the previously described embodiments, the resonator 100 is arranged as a stack 110 of material layers arranged on the substrate 120. The waveguide structure 130 is formed in at least one material layer in the stack and configured to propagate a spin wave 140 and to confine the spin wave 140 propagating in a waveguide element of the waveguide structure 130. The control mechanism 200 is arranged between the substrate 120 and the waveguide element 150. Furthermore, a dielectric layer 155 is arranged between the control mechanism 200 and the waveguide structure 130. The control mechanism 200 is configured to inject a charge into the waveguide structure 130 for adapting the waveguide structure 130 such that the resonance frequency of the waveguide structure of the resonator may be tuned.

It should be noted that FIGS. 6a-h merely show a few examples for influencing, adapting and/or adjusting the waveguide structure 130 via the control structure 200 of the resonator 100 in order to tune the resonance frequency of the waveguide structure 130. Hence, there may be numerous alternatives in the design, configuration and/or operation of the control mechanism 200 for adapting one or more physical (geometrical) and/or magnetic properties of the waveguide structure 130 for tuning the resonance frequency of the waveguide structure 130.

The person skilled in the art realizes that the present invention by no means is limited to the preferred embodiments described above. On the contrary, many modifications and variations are possible within the scope of the appended claims. For example, it will be appreciated that the figures are merely schematic views of devices according to embodiments of the present invention. Hence, the resonator, the elements and/or components of the resonator, etc., may have different dimensions, shapes and/or sizes than those depicted and/or described. For example, one or more layers may be thicker or thinner than what is exemplified in the figures, the stack(s) may have other shapes, depths, etc., than that/those depicted. Moreover, the order of the layer(s) in the stack of material layers may be different than that shown. For example, the control mechanism 200, which is shown to be arranged between the substrate 120 and the waveguide structure 130, may alternatively be arranged on top of the waveguide structure 130. Furthermore, it will be appreciated that the techniques related to the various configurations and/or operations of the control mechanism may be different from those disclosed.

1. Resonator for spin waves, wherein the resonator comprises:
a stack of material layers arranged on a substrate,
a waveguide structure formed in at least one material layer in the stack and configured to propagate a spin wave and to confine a spin wave propagating in a waveguide element of the waveguide structure, such that a spin wave of a selected frequency propagating in the waveguide structure is arranged to resonate in the waveguide structure, and
a control mechanism formed in at least one material layer in the stack and configured to adapt at least one property of the waveguide structure for tuning the resonance frequency of the waveguide structure.

2. The resonator of claim 1, wherein the control mechanism is encompassed by the waveguide structure.

3. The resonator of claim 1, wherein the waveguide element is formed by a magnetic material configured to propagate a spin wave.

4. The resonator of claim 1, wherein the waveguide structure comprises a reflector arrangement configured to confine a propagating spin wave in the waveguide element by reflection of the spin wave.

5. The resonator of claim 4, wherein the waveguide element extends along a principal axis of spin wave propagation, and the reflector arrangement comprises reflective interfaces at the respective ends of the waveguide element.

6. The resonator of claim 5, wherein the reflector arrangement comprises at least one of a periodic reflector array and a Bragg reflector.

7. The resonator of claim 5, wherein the reflector arrangement comprises at least one non-magnetic medium.

8. The resonator of claim 1, wherein the control mechanism is configured to adapt at least one physical property of the waveguide structure.

9. The resonator of claim 1, wherein the control mechanism is configured to adapt at least one magnetic property of the waveguide structure.

10. The resonator of claim 4, wherein the control mechanism is further configured to control at least one property of the reflector arrangement.

11. The resonator of claim 1, further comprising at least one transducer arrangement coupled to the waveguide structure and configured to generate a spin wave in the waveguide structure,
a deformation element configured to change its physical dimensions in response to an electrical actuation, and
a magnetostrictive element coupled to the deformation element,
wherein a change in physical dimensions of the deformation element in response to the electrical actuation results in a mechanical stress in the magnetostrictive element, resulting in a change in magnetization of the magnetostrictive element and resulting in a generation of a spin wave in the waveguide structure.

12. Resonator arrangement, comprising an array of at least two resonators of claim 1, wherein the waveguide structures and control mechanisms of the at least two resonators are arranged on a common substrate.

13. Filter arrangement for processing at least one signal, the filter arrangement comprising
at least one resonator of claim 1,
an electrical input port coupled to the at least one resonator, wherein the electrical input port is configured to transmit an input spectrum, s₁, to the at least one resonator,
wherein the at least one resonator is configured to generate an output spectrum, s₂, based on a resonance of the spin wave in the waveguide structure resulting from the input spectrum,
the filter arrangement further comprising an electrical output port coupled to the at least one resonator, wherein the electrical output port is configured to transmit the output spectrum from the at least one resonator.

14. Method for generating resonance of spin waves using a resonator for spin waves, wherein the resonator comprises:
a stack of material layers arranged on a substrate,
a waveguide structure formed in at least one material layer in the stack and configured to propagate a spin wave and to confine a spin wave propagating in a waveguide element of the waveguide structure, such that a spin wave of a selected frequency propagating in the waveguide structure is arranged to resonate in the waveguide structure, and
a control mechanism formed in at least one material layer in the stack and configured to adapt at least one property of the waveguide structure for tuning the resonance frequency of the waveguide structure, the method comprising the steps of:
propagating a spin wave in the waveguide structure and confining the spin wave propagating in the waveguide element of the waveguide structure, such that a spin wave of a selected frequency propagating in the waveguide structure is arranged to resonate in the waveguide structure, and
adapting at least one property of the waveguide structure for tuning the resonance frequency of the waveguide structure.

15. Method according to claim 14, the method further comprising the step of:
generating a spin wave in the waveguide structure.

16. The resonator of claim 8, wherein the control mechanism is configured to adapt at least one magnetic property of the waveguide structure.

17. The filter arrangement of claim 13, wherein the control mechanism is configured to adapt at least one physical property of the waveguide structure.

18. The filter arrangement of claim 17, wherein the control mechanism is configured to adapt at least one magnetic property of the waveguide structure.

19. The method according to claim 14, wherein the adapting comprises adapting at least one of at least one physical property of the waveguide structure, and at least one magnetic property of the waveguide structure, for tuning the resonance frequency of the waveguide structure.
